(19) United States
(12) Patent Application Publication
(10) Pub. No.: US 2026/0367353 A1
(43) Pub. Date: Nov. 19, 2026

(54) A mechanism for high-speed fiber optic cable feeding to organize a jam-proof channel for controlling moving objects - two versions (Provisional Application #63/650,930 - 05/23/2024).

(71) Applicant: Ruslan Prysiazhnyi, Orlando, FL (US)

(72) Inventor: Ruslan Prysiazhnyi, Orlando, FL (US)

(21) Appl. No.: 19/206,789

(22) Filed: May 13, 2025

(51) Int. Cl. G02B 6/54

(52) U.S. Cl. CPC G02B 6/54

(57) ABSTRACT

A high-speed fiber-optic cable feeding mechanism is disclosed, comprising two alternative designs that enable jam-proof deployment of a fiber-optic tether for remote platforms. In one design, a sealed dome-based feeder encloses a cable reel inside a dome-shaped housing with a central outlet, using a friction brake at the outlet to maintain tension and prevent loops as the cable unwinds. In another design, an open-frame lever-tension feeder employs a spring-loaded articulated lever arm assembly and guide tube to control cable payout, with a braking unit providing drag on the reel. Both designs ensure that the fiber-optic cable deploys smoothly at high speeds without entanglement, thereby preserving a continuous, interference-immune data link. The mechanism is suited for tethering remote-controlled vehicles or drones, offering reliable high-bandwidth communication by preventing cable snarls or breakage during rapid movements. Each variant emphasizes structural features—either an enclosing dome guide or a spring-biased lever system—to achieve novel, jam-resistant operation of a fiber-optic cable reel.

### FIELD OF THE INVENTION

The present invention relates generally to cable deployment systems, and more particularly to mechanisms for feeding fiber-optic cables at high speed in a jam-proof manner. The invention is especially relevant to providing interference-immune data links via fiber-optic tether to remotely controlled mobile platforms.

### BACKGROUND OF THE INVENTION

Remote-controlled and autonomous vehicles, such as unmanned aerial vehicles (UAVs) and mobile robots, often require reliable, high-bandwidth communication links. While wireless radio-frequency links are common, they are susceptible to electromagnetic interference and can be insecure or unreliable in certain environments. Fiber-optic tether systems can provide a secure, interference-immune data link for control signals, telemetry, and video data. However, deploying a fiber-optic cable from a moving platform at high speed presents significant challenges.

One major challenge is cable jamming or tangling during deployment. At high unwinding speeds, a loosely controlled fiber-optic cable can form loops, knots, or snags that jam the reel or even break the delicate fiber. Existing cable reel systems may not adequately maintain tension or may allow slack formation, leading to entanglement. Additionally, prior fiber-optic deployment mechanisms have struggled to combine high-speed payout with jam-proof operation, especially in compact or mobile settings.

Another challenge is protecting the cable and mechanism from environmental factors while ensuring smooth operation. Uncontrolled spooling can cause the cable to whip or coil irregularly, risking damage. Some prior art approaches use simple friction brakes or drag elements, but these alone may be insufficient to prevent sudden jerks or slack loops at very high speeds. There is a need for a deployment mechanism that actively guides and controls the fiber-optic cable to prevent jams without sacrificing deployment speed.

In summary, there is a demand in the field for an improved fiber-optic cable feeder that:
Maintains continuous tension on the cable to prevent slack loops or entanglement during rapid payout.
Operates reliably at high speeds of cable deployment and retraction, suitable for fast-moving platforms.
Optionally encloses or guides the cable to protect it from external interference or snagging on surroundings.
Ensures an interference-free communication link by using fiber-optics, thereby overcoming the limitations of radio links in hostile or EMI-rich environments.

The present invention addresses these needs by providing a high-speed fiber-optic cable feeding mechanism with two novel design variants that overcome the above challenges.

### SUMMARY OF THE INVENTION

The invention is a high-speed fiber-optic cable feeding mechanism designed to deploy and retrieve a fiber-optic cable without jams or tangles, thereby enabling a robust, interference-immune tethered data link to remote mobile platforms. The mechanism is characterized by two independent design variants, each incorporating structural and functional features to maintain cable tension and prevent entanglement during operation. Both variants achieve jam-proof cable deployment through different innovative approaches, focusing on maintaining optimal tension and guiding the cable path during high-speed unwinding.

In one variant, the mechanism is implemented as a sealed dome-based feeder. This first embodiment features a central reel holding the fiber-optic cable, enclosed within a dome-shaped housing that guides the cable as it unwinds. A friction-based braking mechanism is integrated at the cable outlet of the dome. The dome-shaped guide serves to confine and direct the cable outward in a controlled manner, preventing loops from escaping the enclosure. The friction brake applies adjustable resistance to the cable or reel, ensuring that the cable pays out smoothly without overspin or backlash. This enclosed design protects the cable from external elements and passively controls the cable layering and exit trajectory, resulting in a compact, self-contained feeder ideal for harsh environments or mounting on vehicles where protection is paramount.

In a second variant, the mechanism is implemented as an open-frame lever-tension feeder. This embodiment employs a sturdy open frame or base on which the cable reel is mounted, and a spring-loaded articulated arm assembly that actively maintains tension on the cable. As the cable unwinds from the reel, it passes over or through the lever arm assembly which pivots outward, biased by a spring or elastic element. The lever assembly acts as a dynamic tensioner, automatically taking up slack and damping sudden changes in cable tension. The cable then feeds through a guide tube (feed pipe) aligned with the arm, which directs the cable toward the deploying platform or device. A braking unit is incorporated, acting on the reel or the cable, to provide frictional resistance similar to the first variant. The open-frame design allows easy access and maintenance, and the lever mechanism provides active tension control, adapting to variable deployment speeds and accelerations.

Both design variants provide jam-proof operation at high speeds by preventing loose loops and maintaining consistent tension on the fiber-optic cable. They are capable of rapid deployment and retrieval, making them suitable for vehicles or systems that undergo quick maneuvers or high-speed movements. The fiber-optic cable remains taut and properly guided whether the mechanism is paying out or reeling in, thereby safeguarding the integrity of the cable and the continuity of the data link. The interference immunity is inherently provided by the fiber-optic medium, allowing the tethered platform to operate in environments with heavy radio-frequency interference or in applications requiring secure, unjammable communications.

Importantly, the two variants are independent designs that achieve similar results through different means. This provides flexibility in implementation: for example, the sealed dome feeder may be preferred for environmental protection and compactness, whereas the lever-tension feeder may be preferred for modularity and active control of tension. The invention thus covers both approaches, each novel in its structure, to ensure reliable high-speed fiber-optic cable deployment. In both cases, structural and functional details are optimized for maximum reliability, such as the shape of the dome guide or the geometry and spring constant of the lever arm, all aimed at preventing cable snarls or breakage. These improvements represent a significant advancement in the field of tethered communications for remote platforms.

### BRIEF DESCRIPTION OF THE DRAWINGS

FIG. 1 is a cross-sectional side view of a first embodiment of the high-speed fiber-optic cable feeder, illustrating the sealed dome-based feeder. In this figure, the fiber-optic cable is wound on a central reel inside a dome-shaped housing, and a friction braking mechanism is provided at the cable exit at the top of the dome.

FIG. 2 is a side view of a second embodiment of the high-speed cable feeder, illustrating the open-frame lever-tension feeder. The figure depicts a base frame supporting a cable reel and a spring-loaded articulated lever arm assembly. The fiber-optic cable passes through the lever arm system and out through a guide tube, with a braking unit positioned to control the cable tension.

### DETAILED DESCRIPTION OF THE PREFERRED EMBODIMENTS

### First Embodiment: Sealed Dome-Based Feeder

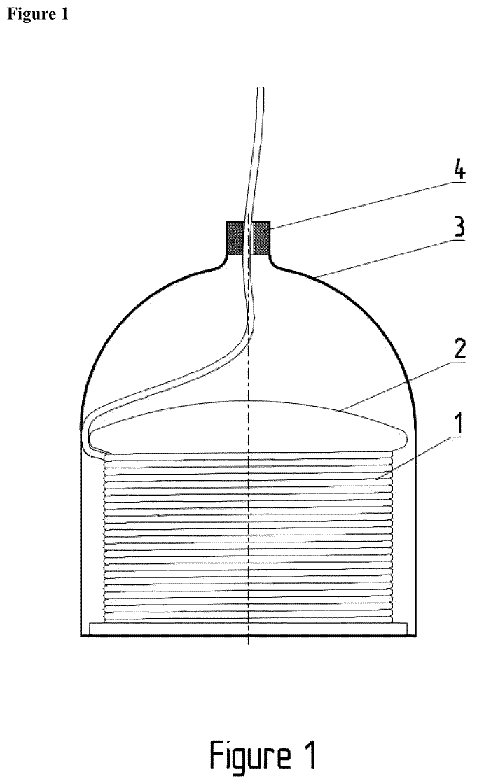

FIG. 1 is a schematic cross-section of a first embodiment, showing a sealed dome-based fiber-optic cable feeder. In this embodiment, a high-strength fiber-optic cable (1) is wound on a central reel (2) that is fixed within a protective housing (3). The housing (3) is generally dome-shaped at its upper portion, forming a smooth guide for the cable (1) as it unwinds. The dome-shaped guide portion of the housing directs the cable toward a central outlet at the top of the dome. Located at this outlet is a friction braking mechanism (4), which engages the cable (or the reel) to provide controlled resistance during deployment.

The reel (2) is typically mounted on an axle or spindle within the housing. The housing (3) completely encloses the reel and the bulk of the cable, except for the outlet through which the cable exits. This sealed housing protects the cable from dust, moisture, and mechanical interference from outside objects. As the cable (1) is pulled and unwound, it slides along the interior surface of the dome, which smoothly guides it upward. The curvature of the dome prevents any sudden or uneven release of coiled cable—if a loop of cable begins to form, it is pressed against the dome and guided into alignment, rather than flailing outward. The dome-shaped guide thus ensures that only a single turn of cable comes off the reel at a time in an orderly fashion.

The friction braking mechanism (4) at the outlet can be realized in various forms. In one preferred form, it consists of a circular brake pad or collar that lightly presses on the cable (1) as it exits, providing a braking force. Alternatively, the brake (4) may act on the reel (2) via a friction clutch or spring-loaded brake shoe that resists the reel's rotation. In either case, the braking mechanism is adjustable to calibrate the tension: it applies enough friction to prevent the reel from overrunning (which would cause slack loops), but not so much as to break the cable or unduly restrict intended movement. The brake may be tuned such that when the cable is pulled at or below a certain maximum acceleration, the cable remains taut and controlled, but if the cable is intentionally retracted or if tension drops, the brake automatically slows the reel.

During operation of the dome-based feeder, as a tethered vehicle moves away and pulls on the fiber-optic cable, the reel (2) turns and the cable (1) feeds out through the top of the dome. The cooperation of the dome guide and the friction brake ensures jam-proof deployment: the cable maintains slight tension, preventing any loose coils from forming inside the housing. If the vehicle slows or stops, the friction brake (4) prevents excess cable from unwinding on its own, thus avoiding entanglement. This embodiment is structurally novel in that it combines a dome-shaped enclosed guide with a calibrated friction brake at the outlet, a configuration which actively suppresses cable loop formation and is not found in conventional open-drum cable reels. The sealed dome feeder is particularly useful when the deployment mechanism must be mounted on an unmanned vehicle or an exposed location, as the housing (3) can also serve as a protective casing and can be made robust against environmental hazards.

### Second Embodiment: Open-Frame Lever-Tension Feeder

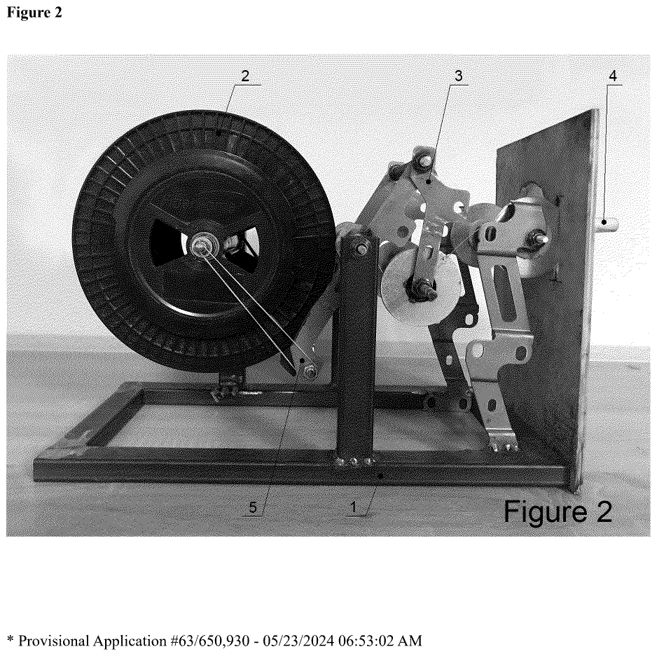

FIG. 2 shows the second embodiment of the invention, an open-frame lever-tension feeder (photograph of a prototype unit). In this embodiment, a base frame (1) provides structural support for the components of the feeder. A reel (2) holding the wound fiber-optic cable is rotatably mounted on the base (1), typically on a central axle or shaft. As the cable unwinds from the reel (2), it passes through a system of levers (3) that form an articulated arm assembly. This lever assembly is pivotally mounted on the frame and is spring-loaded, meaning a spring or elastic element biases the lever arm to a certain position (usually toward the reel). The cable is routed over a pulley or guide on the lever arm such that as tension in the cable changes, the lever arm (3) moves accordingly: it is pulled outward when the cable is tugged quickly, and it springs back to take up slack when tension reduces.

The lever assembly (3) thus functions as a dynamic tensioner. For example, if the tethered vehicle suddenly accelerates away, pulling the cable rapidly, the lever arm will extend (against the spring bias), giving out additional cable smoothly while the spring ensures there is resistance to prevent a sudden jerk. Conversely, if the vehicle slows down or stops pulling, the spring-loaded arm retracts, maintaining tension on the cable and preventing any slack loop from forming around the reel. This continuous adjustment keeps the cable taut between the reel and the guide point, effectively eliminating entanglement even under highly variable speed conditions.

After passing the lever arm assembly (3), the cable runs through a guide tube (4) (also referred to as a feed pipe) which is mounted on an upright portion of the frame (often at the end of the lever path). The guide tube (4) aligns the cable and directs it out of the feeder mechanism toward the remote platform or device being controlled. The tube also serves as a final smooth outlet, preventing the cable from whipping around and providing a fixed exit direction. In the depicted embodiment, the guide tube (4) is a rigid hollow cylinder with a low-friction inner surface, through which the fiber-optic cable slides freely.

A braking unit (5) is provided in this second variant to further control the reel's rotation and cable tension. This braking unit can be a friction brake similar in concept to the first embodiment, acting on the reel (2) or directly on the cable. In one implementation, the brake (5) is a band or disc brake on the reel's axle that can be adjusted to provide a constant drag. In another implementation, the brake could be integrated with the lever mechanism—for instance, a damping element on the lever's pivot that resists rapid movement, thereby indirectly braking the cable movement. The brake (5) works in concert with the lever arm (3) to ensure that the cable does not unwind too quickly. Notably, because the lever tensioner already moderates the cable feed by spring action, the braking unit in this open-frame design can be set to a lighter resistance compared to the dome feeder's brake, primarily engaging only when the lever reaches its travel limit or when fine control is needed.

The open-frame lever-tension feeder is functionally and structurally distinct from the dome-based feeder, yet achieves the same goal of jam-proof, high-speed cable deployment. Its novelty lies in the use of a spring-biased articulated arm to maintain tension, which is not present in traditional spool systems. By actively adapting to changing tension, the mechanism prevents loops from ever forming, rather than just confining them. The simplicity of the open frame (1) also makes it easy to inspect and service. Components like the spring and levers can be tuned (for example, selecting a spring with an appropriate stiffness or adjusting lever arm lengths) to accommodate different cable weights, desired tension levels, and deployment speed profiles. This second embodiment is ideal for installations where real-time adaptive control of cable tension is needed, such as on rapidly moving vehicles or where space for an enclosure is limited.

In both embodiments described above, the fiber-optic cable itself (1) is a high-strength, preferably lightweight cable capable of withstanding the tensile forces encountered during deployment. The cable may include a reinforced jacket or a strain-relief core to handle mechanical stresses. The reel (2) in both cases can include level-wind mechanisms or guide spools if necessary to ensure even winding, although the dome or lever designs largely obviate the need for complicated level-winding by inherently controlling the cable path. The materials for the housing (3) or frame (1) are chosen for durability and weight considerations (for example, aluminum alloy or composite for aerospace use, stainless steel for rugged field use). The braking mechanisms (4, 5) can be manually adjustable or even sensor-controlled (e.g., by a feedback system that detects cable tension and modulates brake force), though in the simplest form a passive friction pad or clutch suffices.

It should be noted that while two distinct design variants have been described, the invention encompasses any fiber-optic cable feeding system that incorporates the key innovative features of maintaining continuous tension and preventing cable jamming during high-speed deployment. For instance, the sealed dome variant could be modified to include a spring element on the reel for additional tension control, or the lever-tension variant could be partially enclosed for protection, without departing from the inventive principles. Modular integration is also possible: the feeder could be mounted on a vehicle, an aircraft, or a stationary launch platform, and it could operate in any orientation (horizontal, vertical, or angled) thanks to the robust tension management. Both designs have been tested in scenarios emulating real operating conditions (e.g., a drone accelerating away from a base station while tethered) and have demonstrated effective performance in maintaining the data link without physical interruption.

In use, an operator or automated system would initialize the fiber-optic feeder by connecting the free end of the cable (1) to the mobile platform to be controlled. As the platform moves, the feeder mechanism automatically pays out cable. The interference-immune nature of the fiber-optic link ensures that even in environments with high electromagnetic noise (for example, around power lines or electronic warfare conditions), the control and communication signals remain robust and secure. The feeder's jam-proof operation means the platform can maneuver freely without the tether snagging or tangling. If the platform returns or the tether needs to be reeled in, the same mechanisms guide the cable back onto the reel smoothly. This bi-directional reliability (both during payout and retract) is another advantageous aspect of the invention, making it suitable for repeated deployments or long-duration use.

By focusing on the structural innovations—the sealed dome guide with friction braking, and the spring-loaded lever arm tensioner with guide tube and brake—the present invention provides a highly reliable fiber-optic cable feeder. These features ensure that the cable deployment is self-regulating to a large extent, requiring minimal intervention or control inputs to prevent tangles. The result is an apparatus that significantly improves upon prior solutions, enabling new applications of tethered fiber-optic systems in high-speed, mission-critical environments.

1. A high-speed fiber-optic cable feeding mechanism for providing a jam-resistant deployment of a fiber-optic communication tether, the mechanism comprising: a reel on which a length of fiber-optic cable is wound; a guiding assembly configured to direct the cable as it is unwound from the reel; a tension-regulating mechanism operatively associated with the reel and the cable to maintain tension during cable payout; and a braking mechanism applying a frictional drag to the cable or the reel, whereby the cable is dispensed at high speed without forming loops or entanglements, thereby maintaining an interference-immune data link to a remotely controlled mobile platform.

2. The mechanism of claim 1, wherein the guiding assembly and tension-regulating mechanism are integrated in a sealed dome-based feeder configuration, comprising a dome-shaped housing enclosing the reel and defining a curved guide path for the cable, and wherein the braking mechanism comprises a friction brake at an outlet of the dome-shaped housing that resists reel rotation and cable movement, such that the housing and brake together prevent the formation of slack loops of cable during deployment.

3. The mechanism of claim 1, wherein the guiding assembly and tension-regulating mechanism are integrated in an open-frame lever-tension feeder configuration, comprising a base frame supporting the reel, an articulated lever arm assembly pivotally mounted on the frame and biased by a spring to tension the cable, and a guide tube through which the cable passes after the lever arm assembly, and wherein the braking mechanism comprises a brake unit acting on the reel or cable to provide frictional resistance, such that the lever arm assembly and brake together maintain continuous cable tension and prevent cable entanglement during deployment.

4. The mechanism of claim 2, wherein the dome-shaped housing includes a central exit aperture at its apex through which the cable (wound on the reel inside the housing) is dispensed, and the friction brake comprises an adjustable pressure pad or collar at said exit aperture that engages the cable to control its speed of exit, wherein the curvature of the dome-shaped housing guides each turn of the cable to said exit aperture in sequence, thereby ensuring only one loop of cable unwinds at a time in an orderly manner.

5. The mechanism of claim 2, wherein the reel is mounted on an axle within the dome-shaped housing, and the braking mechanism further comprises a spring-loaded friction clutch coupled to the axle to prevent free-spinning of the reel beyond a predetermined tension, the clutch being calibrated to allow smooth rotation of the reel under tension but to automatically slow the reel if the cable tension drops below a threshold, thus avoiding backlash and tangling inside the housing.

6. The mechanism of claim 3, wherein the articulated lever arm assembly includes at least one pivoting arm carrying a guide pulley over which the cable passes, and a spring connected to said arm to bias it toward the reel, wherein an increase in cable tension caused by rapid unwinding causes the arm to pivot outward against the spring, and a decrease in tension causes the spring to retract the arm, thereby taking up slack in the cable dynamically.

7. The mechanism of claim 6, wherein the spring is a coil spring or torsion spring adjusted such that the lever arm assembly maintains a substantially constant tension on the cable over a range of deployment speeds, and further wherein a damping element is associated with the lever arm's pivot to absorb sudden movements, providing an additional braking effect on the cable during abrupt acceleration or deceleration of the reel.

8. The mechanism of claim 3, wherein the guide tube is a fixed hollow conduit aligned with the path of the cable as it leaves the lever arm assembly, the guide tube having a smooth interior surface and being oriented to direct the cable toward the mobile platform, such that the guide tube further prevents lateral movement of the cable and eliminates the possibility of the cable snagging on external objects immediately upon exit from the mechanism.

9. The mechanism of claim 3, wherein the brake unit comprises a friction brake pad or band operatively connected to the reel, the brake unit being adjustable to set a baseline drag on the reel's rotation, wherein the combination of the brake unit and the spring-biased lever arm assembly yields a two-stage tension control (passive friction plus active spring tensioning) that permits high-speed cable deployment while instantaneously correcting any slack.

10. The mechanism of claim 1, wherein the fiber-optic cable forms an interference-immune data link for control or communication with the remotely controlled mobile platform, and the mechanism is mounted on a host platform or base station, the mechanism further comprising a retrieval drive operatively connected to the reel for rewinding the cable, such that when reeling in the cable, the guiding assembly and tension-regulating mechanism cooperate to lay the cable onto the reel without overlap or knots, thereby providing jam-free operation in both deployment and retraction.

11. The mechanism of claim 1, wherein the fiber-optic cable feeding mechanism is configured for use on an unmanned vehicle, drone launch system, or mobile spool cart, and is capable of operating in any orientation, the mechanism further including shock absorbers or vibration dampers to protect the reel and cable during motion of the host platform, whereby the integrity of the cable and consistency of the data link are maintained even under dynamic conditions.
